(19) United States
(12) Patent Application Publication
(10) Pub. No.: US 2020/0305371 A1
(43) Pub. Date: Oct. 1, 2020

(54) VERTICAL PLANT CULTIVATION CLOSED SYSTEM

(71) Applicant: Mankaew MUANCHART, Muang Surin (TH)

(72) Inventor: Mankaew MUANCHART, Muang Surin (TH)

(21) Appl. No.: 16/310,400

(22) PCT Filed: May 30, 2017
(86) PCT No.: PCT/TH2017/000041

§ 371 Date: Dec. 14, 2018

(30) Foreign Application Priority Data
Jun. 16, 2016 (TH) 1601003575

(51) Int. Cl. A01G 31/06; A01G 7/04

(52) U.S. Cl. CPC A01G 31/06; A01G 7/045

(57) ABSTRACT

According to aspects of the present invention there is provided the vertical plant cultivation closed system comprising:

Reduce the old apparatus of fogponics system and reduce the movement of the nutrient atomized mist. Control the direction of the movement of the nutrient atomized mist by throw upper through plant root fix point. The nutrient atomized mist descent to level that based on the nutrient atomized mist density constantly. By fix the station of HOF (5) on top of the lie of plant root fix point at least one position.

### TECHNICAL FIELD

The present invention relates to biotechnology, plant growing system, apparatus and method, in particular fogponics plant cultivation closed systems.

### BACKGROUND

A system of fogponics farming was developed from aeroponics farming system. A system has ultrasonics head, that send high frequency wave for vibrating water and the nutrient solutions. Then water was vibrated by high frequency wave, they volatiled and transformed to fog without heat. Volatiled fog float through the upper air and sticked by roots. From researching, the ultrasonic head was installed nearby the bottom of plant pot. Then there fog float to stick the root plant. But volatiled fog float through its limit 2 foots height, so that the water system necessary installed fan that fixing upper plant pot for pulling fog solutions. Fan generate the fog float pass up.

According to co-pending U.S. Pat. No. 5,136,804 A, the water system was installed ultrasonic head and pushing fan to bottom of plant pot for pushing the fog float higher, whereas the fan is upper the ultrasonic head.

But the problems of fogponics system that can not apply and suitable for planting in commercially industrial.

1. A water system was installed upper the pulling fan on tower plant pot, that can not pull the fog to flow high enough. The level height of fog vary by power of pulling fan. For high enough power pulling fan, a the fog flow higher than using low power fan, but the higher fog flow system trade of the higher temperature in closed system. Then plant in the upper of tower pot may die by the high temperature of pulling fan. But the low tower pot have low productivity therefore can not use in commercially industry.

2. A system of fogponics and aeroponic is distinct from other soil-less plant system. In fogponics system, the roots are sticked by the fog and moistured all time. As system fail then roots were not sticked by fog more than 12 hours, the roots were dry and plant dead rapidly. A fogponics system necessary has the pulling fan in every pots, that is the main problem for applying fogponics in commercially industry. The pulling fan was the very important factor for fogponics system.

Some researcher shown problem solution to install sensors all every plant plots. But this method has high cost and the plant is low price product, so that a fogponics system is not suitable for commercial industry.

### SUMMARY OF INVENTION

According to aspects of the present invention there is provided the vertical plant cultivation closed system comprising:

Reduce the old apparatus of fogponics system and reduce the movement of the nutrient atomized mist. Control the direction of the movement of the nutrient atomized mist by throw upper through plant root fix point. The nutrient atomized mist descent to level that based on the nutrient atomized mist density constantly. By fix the station of HOF (5) on top of the lie of plant root fix point at least one position.

### BRIEF DESCRIPTION OF THE DRAWINGS

An embodiment, incorporating all aspects of the invention, will now be described by way of example only with reference to the accompanying drawing in which

FIG. 1 is block diagram of a plant cultivation closed system in accordance with an embodiment of the system.

### DETAILED DESCRIPTION

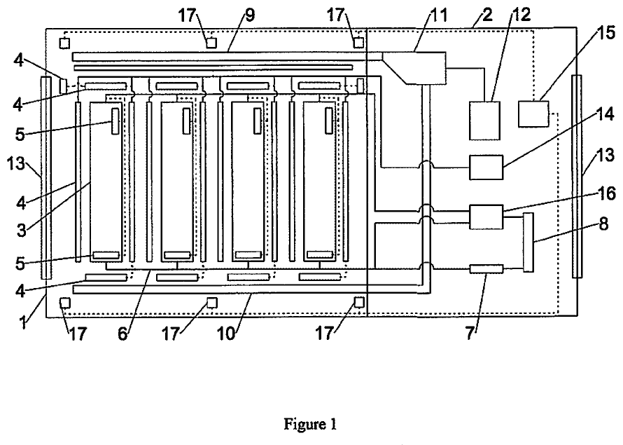

This purposed “closed system” as shown in the present invention is plant growing technique that close all space, can be controlled the environment of closed system. As shown in FIG. 1, that can be described the closed system. The purposed system separate space to 2 parts, one is growing space (1) that consist of 4 side walls and upper/lower walls, two be the environment control unit (2) that separate definitely from the other side wall. The light sources (4) is send by light control unit (14), that signal transmitted through wire system. The sound sources (17) is send by sound control unit (15). The air movement and temperature sources (9) is installed between two parts and connected by air movement and temperature control unit (10). The growing space (1) and the environment control unit (2) have one exit (13) for carrying plants in and out closed system, and maintain this system.

The management of closed system environment and its control system includes of light sources (4) that fixed on the upper side wall or four side walls and/or between the tower pot (3) for emitting light. As for researching the light intensity effects to plant grown rate. The light intensity of red light and blue light is the two most effective light source for plant grown rate. The other kind of plants and the other period of grown plant want a verification light intensity adjustment. For example, the leaf plant period want high red light intensity more than blue light.

The operation of light sources (4) was connected to light control unit (14) that fixed in the environment control unit (2), that control the light intensity. Sound sources (17) can be installed at all six side walls and outer plant pots in the growing space (1). As for researching, sound effected to plant grown rate. A kind of sound suitable for plant growing is music. And a kind of music that very suitable is classical music. The sound sources can be fixed at all side walls and wired through sound control unit (15) in environment control unit (2). The air movement and temperature sources (9) can be installed at four side walls and upper/bottom side walls. The operation of air movement and temperature sources (9) describe how to carry carbon dioxide from gas tank (12) through air movement and temperature control unit (11) then the controlled air at (9) flow through next control unit. The air movement control unit (10) generated the flowing air movement and flow through the air movement and temperature control unit (11) again. A suitable temperature based on type of plants. As for learning and researching, the closed system should have the resistance of insulator 15-45 Hr sqr. Ft deg.F/BTU for controlling temperature to 5-35 degree Celsius.

Air movement is one of effective parameter to plant grown rate. Air movement sources should be fixed suitable and air movement rate should be 0.5-3 m/s, that can carry carbon dioxide 500-2000 micro mol/mol to every plants in the growing space continuously and do not remain oxygen sticked at plant leaf. Air movement control the humidity around plant leaf fix to 40-80 percent base on a type of plants.

The cultivation system has many the nutrient feeding technique according to its system, for example hydroponics, aquaponics, aeroponics and fogponics. The necessary the nutrient atomized mist was feed to closed system in form of the nutrient solutions. Then the different plant growing system has different feeding method. For example, hydroponics has feed necessary the nutrient solutions in form of liquid. The fogponics has feed necessary the nutrient solutions in form of the nutrient atomized mist.

The present invention describe the feeding technique of fogponics. Plant is situate in the tower pots (3) and their roots is fixed at the interior of the tower pots. The nutrient atomized mist is generated by humidifier or fog generator (HOF) (5) through plant roots, then transform back to the nutrient atomized mist solution and be gathered by the nutrient atomized mist return tray (6) which preferably returns to the nutrient atomized mist solution to recycle tank (7) and recycle back. Then the nutrient atomized mist solution is transformed to deionized water and store in the nutrient atomized mist tank (8). And then feed its to the nutrient atomized mist at the solution fog generator (16) for spraying at HOF (5) again. Whereas the nutrient atomized mist return tray (6) and the solution fog generator (16) has for some tube connected the solution fog generator (16) controlling system humidity constantly.

According to aspect of the present invention vertical plant cultivation closed system is described as close system of plant grown culture, that including of,

A. HOF (5) can be selected between (i) ultrasonics head and/or (ii) the nutrient atomized mist tube that connected the solution fog generator (16). Fog solution generator (16) and HOF (5) are generate high frequency, that frequency is higher than sound wave, and the suitable frequency is 1-7 mega hertz. The most suitable frequency is 1-5 mega hertz for generating 3-7 microns, the nutrient atomized mist solution that suitably for fogponics closed system.
B. Tower pot (3) is the system pot that can be grown plant in vertical dimension. The tower pot is very special suitable pot for closed system, comprising:
1. The surface area of tower pot (3) is measured from inner pot. And its area should be at least 0.01-1 square meter. The suitable pot area is 0.01-0.5 square meter for controlling the nutrient atomized mist intensity to 100 percent humidity.
2. The material of tower pot (3) is reasonable selected by considered cost, less erosion and light weight that suitable to closed system temperature. From researching the suitable material which manufacture tower pot are polyvinyl chloride, polyethylene, polypropylene, stainless steel 316L, stainless steel 304 or stainless steel 308 or equivalent. The most appropriate material is less erosion light weight and low cost is polyvinyl chloride.
3. The preparation of plant root fix point has two main design, the first one is molded by stainless steel 316L 304 308 or equivalent, or formed by plastic used from polyvinyl, polyethylene, polypropylene. The other design is made form normal pot by cutting it circularly around pot. The cut hole is circle or N-polygon or proximity, and its diameter is 30-50 millimeter, then connect it with plant tubes circularly wherein plant tubes connected, we count in the plant root fix point also. The most suitable diameter of cut hole is 35-40 millimeter, because this dimension is suitable for growing plant in closed system.
4. The plant root fix point from the tower pot (3) is angled at 30-80 degree and multiple it in the vertical dimension. Because of its angle, this system is different from other plant closed system. For relating to light control in the closed system and most growth, the suitable angle is 45 degree.
5. The tower pots (3) have reflexing surface that can scatter light to every area in the closed system. According to plastic coating technique, filming surface or the original color of plastic that its photosynthetic photon flux density should be 100-1000 micron mol/sqr.m sec. The suitable photosynthetic photon flux density is 100-500 micron mol/sqr.m. sec.
6. The highest plant root fix point of tower pot (3) is set up far from HOF (5) around 8-50 centimeters. The optimal distance is 8-13 centimeters for preventing the plant from side wall and/or upper wall and/or HOF (5). The base of tower pot (3) and lowest plant root fix point should have optimal distance around 8-30 centimeters and the most optimal range is 8-13 centimeters. For controlling the length of plant roots in closed system. The present invention closed system set distance between plant root and the base of tower pot (3) shorter than the other system because of light controlling technique.

From research the flow of fog molecule in the fogponics system, direction of fog solution molecule was push and/or pull upper through plant root fix point and returned to standing zero velocity. Then water and solution dripped down to level that based on fog density. Fog was turned to solution at same the level of plant roots. The new purposed of the present invention control the direction of nutrient atomized mist was eliminated the first section of fogponics, push/pull the nutrient atomized mist solution and return zero velocity, but throwing the nutrient atomized mist down to plant root then make its density constantly.

It is an object of the present invention to throw the nutrient atomized mist from tower without fan. The nutrient atomized mist make it constant density speedily more than other fogponic system. Because the distance of the nutrient atomized mist movement is shorter. The nutrient atomized mist move to the constant grain density speedily because it doesn't have heat from fan. It is an object of the present invention to control the direction movement of the nutrient atomized mist is identify the position of HOF (5) above the plant rot fix point on the tower pot (3) at least one position.

1. Vertical plant cultivation closed system consist of close all space, can be controlled the environment of closed system has growing space (1) that consist of 4 side walls and upper/lower walls, two be the environment control unit (2) whereas control light, temperature and air movement of growing space (1), comprising : A tower pot (3) has for some the plant rot fix point angled at 30-80 degree and multiple it in vertical dimension. And identify the position of HOF (5) above the plant rot fix point on the tower pot (3) at least one position.

2. Vertical plant cultivation closed system in accordance with claim 1 wherein the plant root fix point in the highest tower pot (3) is set up far from the HOF (5) around 8-50 centimeters.

3. Vertical plant cultivation closed system in accordance with claim 1 wherein the HOF (5) can be selected between the ultrasonics head and/or the nutrient atomized mist fog tube from HOF (5). HOF (5) generate suitable high frequency is 1-7 mega hertz for generating the suitable nutrient atomized mist is 3-7 microns.

4. Vertical plant cultivation closed system in accordance with claim 1 wherein the base of tower pot (3) and lowest plant root fix point should have optimal distance around 8-30 centimeters.

5. Vertical plant cultivation closed system in accordance with claim 1 wherein said the vertical plant cultivation closed system comprising the closed system separate space to 2 parts, one is growing space (1) that consist of 4 side walls and upper/lower walls, two be the environment control unit (2) that separate definitely from the other side wall. The light sources (4) is send by light control unit (14), that signal transmitted through wire system. The sound sources (17) is send by sound control unit (15). The air movement and temperature sources (9) is installed between two parts and connected by air movement and temperature control unit (10).
Light sources (4) that fixed on the upper side wall or four side walls and/or between the tower pot (3) for emitting light. The operation of light sources (4) was connected to light control unit (14) that fixed in the environment control unit (2).
The air movement and temperature sources (9) can be installed at four side walls and upper/bottom side walls in growing space (1). The operation of air movement and temperature sources (9) describe how to carry carbon dioxide from gas tank (12) through air movement and temperature control unit (11) then the controlled air at (9) flow through next control unit. The air movement control unit (10) generated the flowing air movement and flow through the air movement and temperature control unit (11) again. And controlling temperature to 5-35 degree Celsius.
Air movement sources should be fixed suitable and air movement rate should be 0.5-3 m/s, that can carry carbon dioxide 500-2000 micro mol/mol to every plants in the growing space continuously and do not remain oxygen sticked at plant leaf. Air movement control the humidity around plant leaf fix to 40-80 percent.

6. Vertical plant cultivation closed system in accordance with claim 1 wherein the material of tower pot (3) is any one of polyvinyl chloride, polyethylene, polypropylene, stainless steel 316L, stainless steel 304 or stainless steel 308 or equivalent.

7. Vertical plant cultivation closed system in accordance with claim 1 wherein the plant root fix point has two main design, the first one is molded by stainless steel 316L 304 308 or equivalent, the second is formed by plastic used from polyvinyl, polyethylene, polypropylene connect in the tower pot (3).

8. Vertical plant cultivation closed system in accordance with claim 7 wherein the plant root fix point's design is made form normal pot by cutting it circularly around pot. The cut hole is circle or N-polygon or proximity, suitable diameter is 30-50 millimeter, then connect it with plant tubes circularly wherein plant tubes connected, we count in the plant root fix point also.

9. Vertical plant cultivation closed system in accordance with claim 1 wherein the tower pots (3) have suitable the photosynthetic photon flux density is 100-1000 micron mol/sqr.m sec.

10. Vertical plant cultivation closed system in accordance with claim 1 wherein sound sources (17) can be installed at all six side walls and outer plant pots in the growing space (1) is send by sound control unit (15) in the environment control unit (2).
